(19) United States
(12) Patent Application Publication
(10) Pub. No.: US 2011/0292066 A1
(43) Pub. Date: Dec. 1, 2011

(54) Soft Disk Blue Noise Sampling

(75) Inventor: Li-Yi Wei, Redwood City, CA (US)

(73) Assignee: Microsoft Corporation, Redmond, WA (US)

(21) Appl. No.: 12/789,445

(22) Filed: May 27, 2010

(51) Int. Cl. G09G 5/00; G09G 5/02

(52) U.S. Cl. 345/589; 345/581

(57) ABSTRACT

Techniques for providing soft disk sampling are described. A soft disk sampling process receives input of a sampling domain, which may include samples associated with one or more sample classes. The soft disk sampling process defines and calculates energy functions for the candidate samples. Based on the calculated energy functions, the soft disk sampling process generates output of a sample set by selecting the candidate samples from one or more sample classes. Each sample class and the sample set exhibit blue noise distribution. The number of sample classes and the number of samples may be specified for each sample class.

The techniques include placing the sample set in both discrete and continuous sample spaces. Furthermore, the techniques support adaptive sampling and arbitrary sample space dimensionality.

### BACKGROUND

Sampling is a core process for a variety of graphics applications. Sampling is the process of selecting samples from a sampling domain to produce images for the graphics applications. However, different graphics applications may desire particular sampling patterns. One sampling pattern that has been widely adopted is Poisson disk sampling. Poisson disk sampling evaluates a distribution of cones in an extrafoveal region of the eye of a rhesus monkey (i.e., primate retina cells), which is similar to that of a human eye. This distribution contains samples that are randomly located but remain at least a minimum distance away from each other. The resulting sample set has a blue noise power spectrum for graphics applications. Blue noise is described as noise with a signature lack of low frequency energy and structural bias.

Research efforts in sampling have mainly focused on Poisson disk sampling. However, the approach in Poisson disk sampling tends to focus on a single class of sample. The single class approach treats all samples in the sampling domain in the same manner.

Another technique used in sampling is color halftoning Color halftoning computes colors for a given set of discrete samples. However, color halftoning often relies on iterative optimization, which is often slow, complex, and restricted to uniform, regular discrete sampling. Furthermore, color halftoning is not applicable for general purpose sampling in graphics that may require computing both color and position information.

### SUMMARY

This disclosure describes soft disk sampling by processing a sampling domain for providing output of a sample set to be used in graphics applications. The term soft disk may be defined as being deformable for the soft disk sampling process.

In an implementation, a soft disk sampling process receives input of the sampling domain applicable for image applications. The sampling domain includes samples associated with one or more sample classes. The soft disk sampling process calculates energy functions for the samples associated with the one or more sample classes. Based at least in part on the calculated energy functions, the soft disk sampling process generates a sample set by selecting the samples to fill the one or more sample classes. Each generated sample class and the union sample set exhibit a blue noise distribution.

In another implementation, a soft disk sampling process selects a sample class from a sampling domain. The class selected is currently a most under-filled class among at least two or more sample classes. This selection by the soft disk sampling process provides an identified sample class. Based on the identified sample class, the soft disk sampling process generates a candidate sample from the sampling domain by using a random selection technique. The candidate sample selected is associated with the identified sample class. The soft disk sampling process calculates an energy value of the candidate sample from the sampling domain. The soft disk sampling process produces a sample set by selecting the candidate samples based on the calculated energy value of the candidate sample with a minimum energy value, to fill at least two or more sample classes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a flowchart showing illustrative phases for providing the soft disk sampling for use by an architecture of FIG. 2. The phases include: to receive a sampling domain and the user specification for the number of sample classes and number of samples per class to calculate an energy function, to generate a sample set of samples, and to apply the sample set of samples in a variety of graphics applications.

FIG. 2 illustrates the architecture to support an illustrative environment for providing soft disk sampling for graphics applications.

FIG. 3 is a block diagram showing an illustrative computing device usable with the architecture of FIG. 1.

FIG. 4 is a flowchart showing an illustrative process of processing sampling data for soft disk sampling.

FIG. 5 illustrates examples of soft disk sampling for three sample classes and a total set with samples from the three classes.

FIG. 6 is a flowchart showing an illustrative process of calculating the energy function of a sample.

FIG. 7 is a flowchart showing an illustrative process of generating the sample set of soft disk samples.

FIG. 8 is a flowchart showing an illustrative process of applying the generated sample set of soft disk samples for the graphics applications.

FIG. 9 illustrates an example of object placement by soft disk sampling, illustrating uniform sampling results.

FIG. 10 illustrates an example of object placement by soft disk sampling, illustrating adaptive sampling results.

### DETAILED DESCRIPTION

### Overview

This disclosure describes an architecture and techniques for soft disk sampling. Soft disk sampling is a process that occurs by receiving a sampling domain and user specification for the number of classes and number of samples per class, and generating an output of a set of soft disk samples for graphics applications. The soft disk sampling process selects the samples from the sampling domain based on calculated energy functions.

The set of soft disk samples is used in a variety of graphic applications for rendering, imaging, and geometry processing. For example, the set of soft disk samples may be used for general purpose sampling in graphic applications that may involve computing both color and position information. In particular, the set of soft disk samples is applicable to applications that prefer more uniform spatial distribution and exact specification for a number of samples from each sample class.

The input of the sampling domain includes one or more classes of samples. A sample class refers to a collection of samples or objects. The collection may be defined based on at least one common characteristic of the samples.

The term “soft disk” refers to a deformable geometric shape. A soft disk is centered on each sample from the sampling domain. This soft disk centering helps the samples to behave like energy blobs with local support. As a result, the samples may be referred to as soft disk samples. The soft disk samples have no hard boundaries, so they can intersect each other. However, the amount of overlap is subject to an energy penalty.

The energy value or the energy function of the soft disk sample is calculated by first centering a Gaussian blob around any sample. A desired goal is to select the soft disk samples having a minimal energy value, also referred to as a minimal energy function. When the energy value or energy function of the soft disk sample is minimized, a uniform distribution is produced.

In an example of simplification, a threshold energy value may be specified to speed up the process of selecting samples from the sampling domain. The soft disk sampling process involves identifying candidate samples from the sampling domain in many trials. By specifying the threshold energy value, fewer trials are performed. The threshold energy value helps to terminate the trials quickly. Thus, a candidate sample with the energy value that is less than the threshold energy value is identified and selected for the sample set.

An advantage of having multiple sample classes of soft disk samples generated is that they are applicable to a variety of natural or man-made phenomena. For example, the multiple classes of soft disk samples generated permit placing multiple categories of objects in a graphics application or using multiple-colored dots for stippling in another application. Furthermore, the multiple classes of soft disk samples generated may be placed in both discrete and continuous sample spaces. Also, the techniques described may place the multiple classes of soft disk samples generated in adaptive sampling and arbitrary sample space dimensionality.

The techniques described provide each generated individual class of soft disk samples as well as their union to exhibit blue noise distribution. In addition, soft disk sampling may specify a number of samples from the sample class for the sample set. Another advantage of the soft disk sampling is that it produces the distribution with more spatial uniformity, while offering explicit control for determining a number of samples from each sample class.

While aspects of described techniques can be implemented in any number of different computing systems, environments, and/or configurations, implementations are described in the context of the following illustrative computing environment.

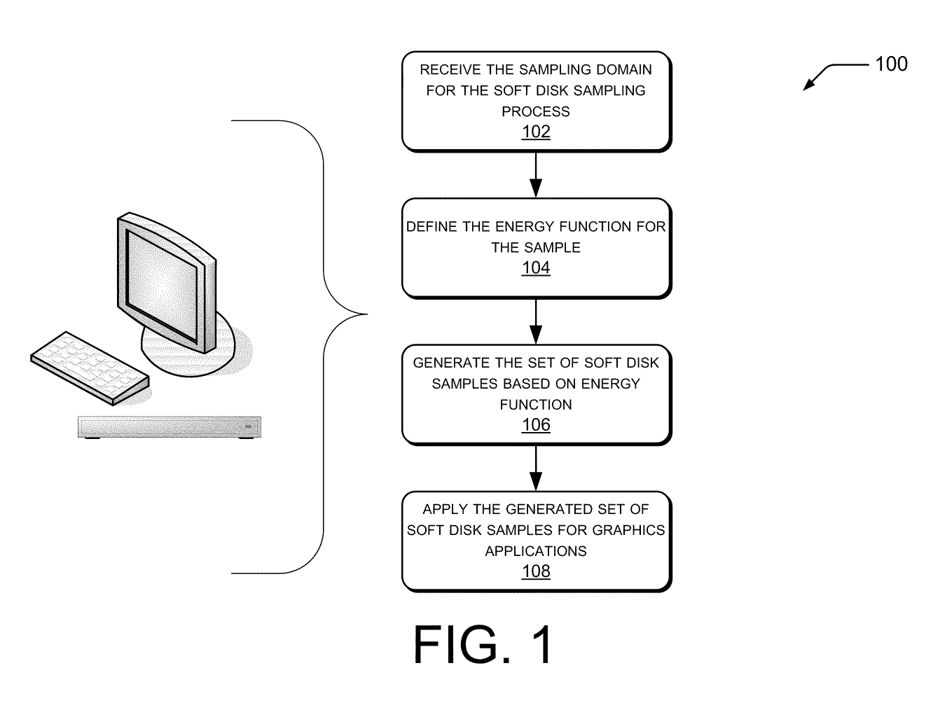

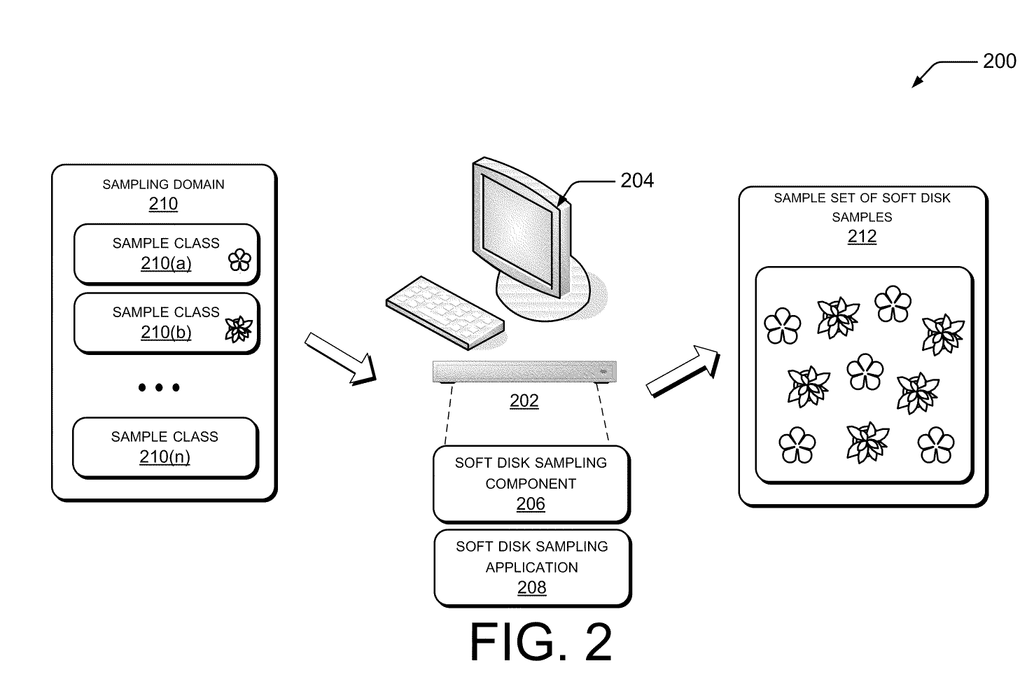

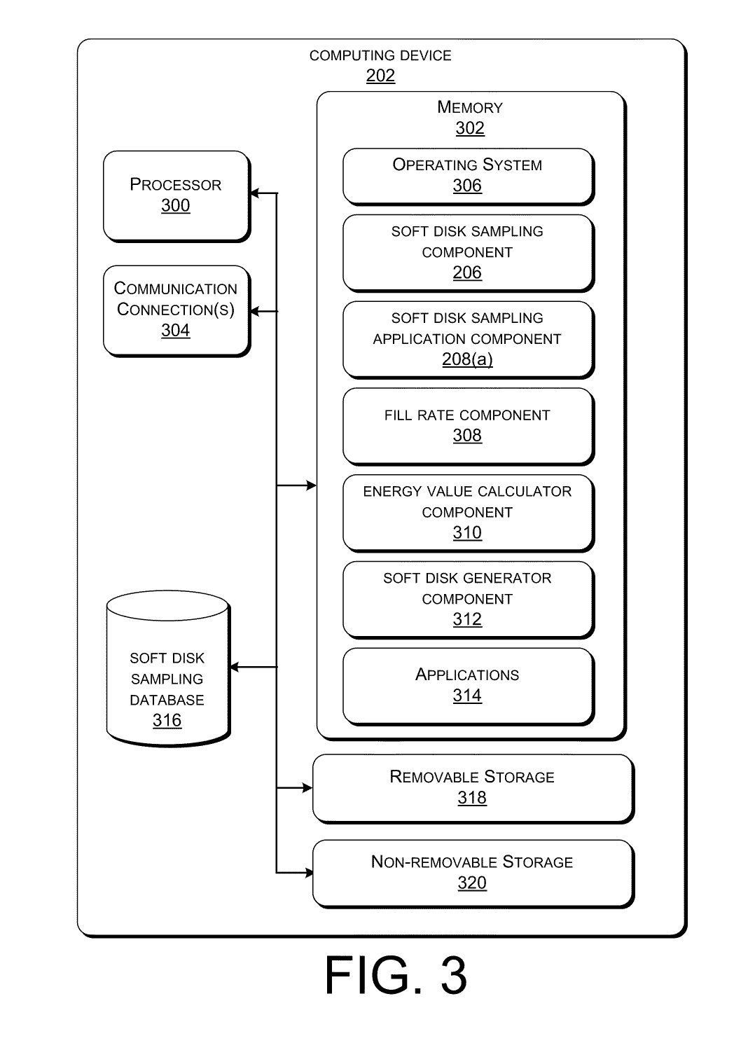

FIG. 1 is a flowchart showing an illustrative overview process 100 of high level functions performed by a soft disk sampling process in operation with components on a computing device. The architecture and components are discussed in FIGS. 2 and 3, respectively. The process 100 may be divided into four phases, an initial phase to receive the sampling domain for the soft disk sampling process 102, a second phase to define an energy function for the sample 104, a third phase to generate the set of soft disk samples based on the energy function 106, and a fourth phase to apply the generated set of soft disk samples for graphics applications 108. All of the phases may be used in the environment of FIG. 2, may be performed separately or in combination, and without any particular order.

The first phase is to receive a sampling domain for the soft disk sampling process 102. The sampling domain may refer to a group of data items including one or more sample classes. Each sample class refers to a collection of samples having at least one common characteristic. In another implementation, this phase may also include receiving a number of classes and a number of samples per class as specified by a user.

The second phase is to define the energy function for the sample 104. The energy function quantifies sample uniformity while evaluating a weight factor for a class combination. Also, the energy function calculates a variance as a function of a sample pair (including a candidate sample and any sample in the sample set). The energy function is calculated in an iterative manner when the samples are generated or updated.

The third phase is to generate the set of soft disk samples based on the energy function 106. Trials are performed for candidate samples selected from the sampling domain. The energy functions are calculated for the candidate samples from defining the energy function for the sample 104. Based on the energy functions calculated, the candidate samples are accepted or rejected for the set of soft disk samples. In another implementation, a threshold energy value may be specified to speed up the soft disk sampling process.

The fourth phase is to apply a generated set of soft disk samples for graphics applications 108. The graphics applications may include, but are not limited to, uniform object placement, color stippling, sensor layout, and color filter array design. Details of the phases are discussed in FIGS. 2-9 below.

### Illustrative Environment

FIG. 2 is a diagram of an illustrative architectural environment 200 that includes the computing device and a soft disk sampling application for receiving input of the sampling domain, processing the soft disk samples, and providing output of the sample set of soft disk samples for graphics applications. In particular, the environment 200 includes the computing device 202, which is shown as a desktop computer. The computing device 202 may take a variety of forms, including, but not limited to, a portable handheld computing device (e.g., a personal digital assistant, a smart phone, a cellular phone), a laptop computer, a portable media player, a tablet computer, a netbook, or any other device capable of processing samples.

The computing device 202 may include a monitor 204 to display the soft disk sampling process and the output of the sample set used in the graphics applications. The monitor 204 may display individual sample classes as well as the union of the sample classes. The union of the sample classes may be referred to as a total set or the sample set.

The computing device 202 may include a soft disk sampling component 206, a soft disk sampling application 208, or a module that performs the various soft disk sampling functions or processes. The term “component” encompasses any functionality for performing a task. For example, each operation illustrated in the flowcharts corresponds to a component for performing that operation. The soft disk sampling component 206 may include additional sub-components, sub-modules, or work in conjunction with other modules or components to perform the operations discussed below.

In an implementation, the soft disk sampling component 206 may be implemented at least in part by the soft disk sampling application 208 executed by a processor of the computing device 202. The soft disk sampling component 206 processes information such as receiving input of sampling domain, receiving other input information, producing output, and the like.

In the illustration, the soft disk sampling component 206 receives input information of the sampling domain 210. The term “sampling domain” may refer to a continuous space, a group of data items, samples of items, image elements, objects, and the like. The sampling domain 210 may include one or more sample classes, such as sample class 210(a), sample class 210(b) . . . sample class 210(n). A sample class refers to the collection of samples or objects based on at least one common characteristic or at least one common property of the samples. For example, the sample class 210(a) is illustrated with a sample object of a flower with five rounded petals while the sample class 210(b) is illustrated with a sample object of another flower with 10 or more pointed petals. The collection or common characteristic for the sample class is associated with flowers. The differences may be due to a number of petals, a color of the petals, or a type of the petals.

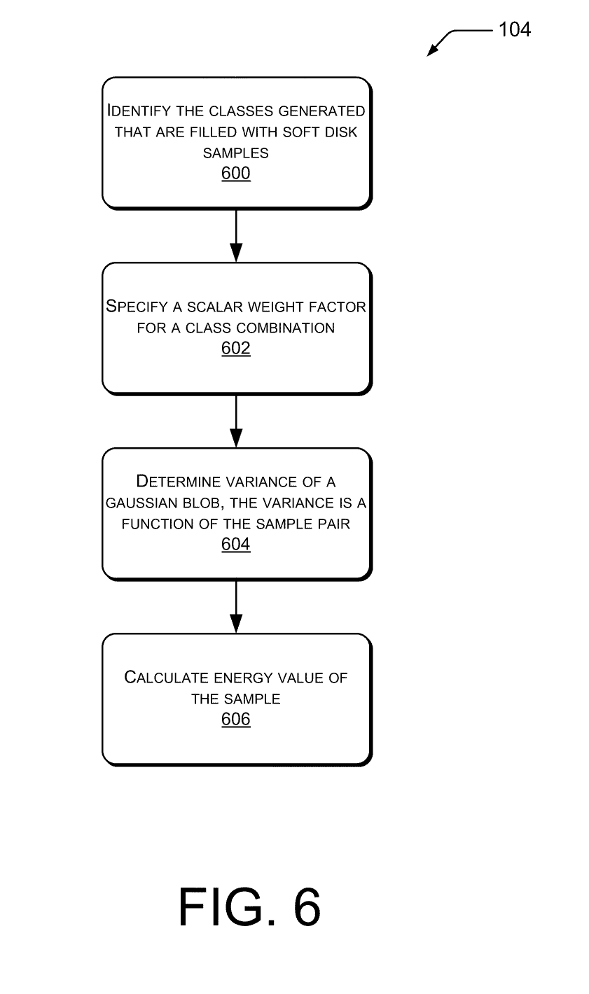

The soft disk sampling component 206 processes the input information by receiving the sampling domain 210. The soft disk sampling process calculates energy functions or energy values for candidate samples associated with the one or more sample classes from the sampling domain 210. Once the energy functions or energy values are calculated, the soft disk sampling process determines whether to accept or reject the candidate samples for the sample set of soft disk samples 212. This is described in more detail in FIG. 6.

In the illustration, the soft disk sampling component 206 accepts the soft disk samples from the two sample classes 210(a), 210(b) based on the calculated energy values. Shown in the sample set of soft disk samples 212 are the two classes of objects, the sample class 210(a) of the flower with five rounded petals and the sample class 210(b) of the flower with 10 or more pointed petals. Thus, the generated sample set of soft disk samples 212 show the samples from the two different classes of objects, 210(a), 210(b).

### Illustrative Computing Device

FIG. 3 is a block diagram showing an illustrative computing device usable with the high level functions of FIG. 1 and the environment of FIG. 2. The computing device 202 may be configured as any suitable system capable of services, which includes, but is not limited to, implementing the soft disk sampling component 206. In one illustrative configuration, the computing device 202 comprises at least one processor 300, a memory 302, and a communication connection(s) 304. The communication connection(s) 304 may include access to a wide area network (WAN) module, a local area network module (e.g., WiFi), a personal area network module (e.g., Bluetooth), and/or any other suitable communication modules to allow the computing device 202 to communicate over the network(s).

Turning to the contents of the memory 302 in more detail, the memory 302 may store an operating system 306, the soft disk sampling component 206, a component for the soft disk sampling application 208(a), a fill rate component 308, an energy value calculator component 310, and a soft disk generator component 312. Furthermore, there may be one or more applications 314 for implementing applications and/or services, such as email, voicemail, and the like.

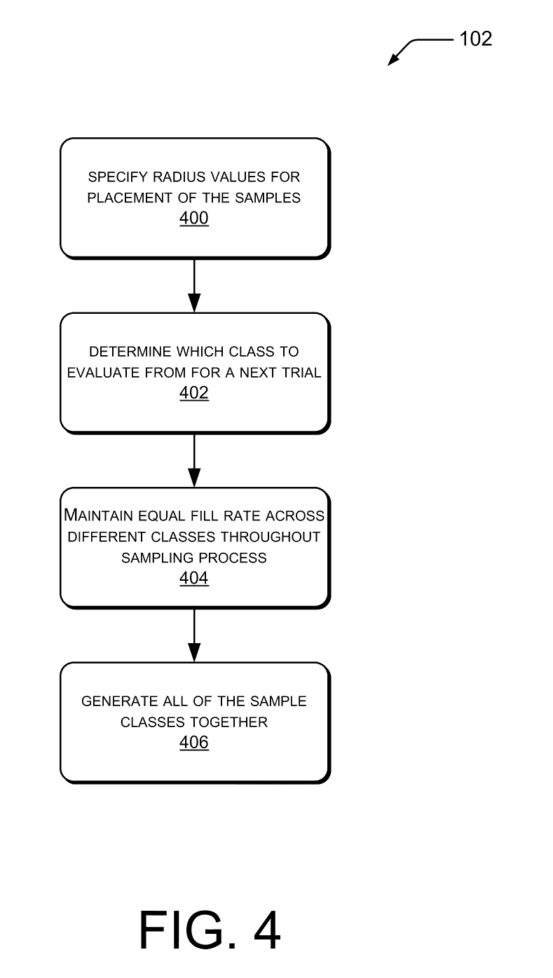

The soft disk sampling component 206 may work in operation with the soft disk sampling application component 208(a). The functions described may be performed by the soft disk sampling component 206 and/or the soft disk sampling application component 208(a) or even other components. The soft disk sampling component 206 receives many types of input information, including input of the sampling domain, input of user specified number of samples per class, input of radius values, and any other type of input information. It also performs trials for the candidate samples, selects the samples from the different sample classes, and interacts with the other components to provide a number of samples produced in each sample classes to be used for graphics applications. The radius values determine a placement of the samples. Detailed discussion of the radius values follow in FIG. 4.

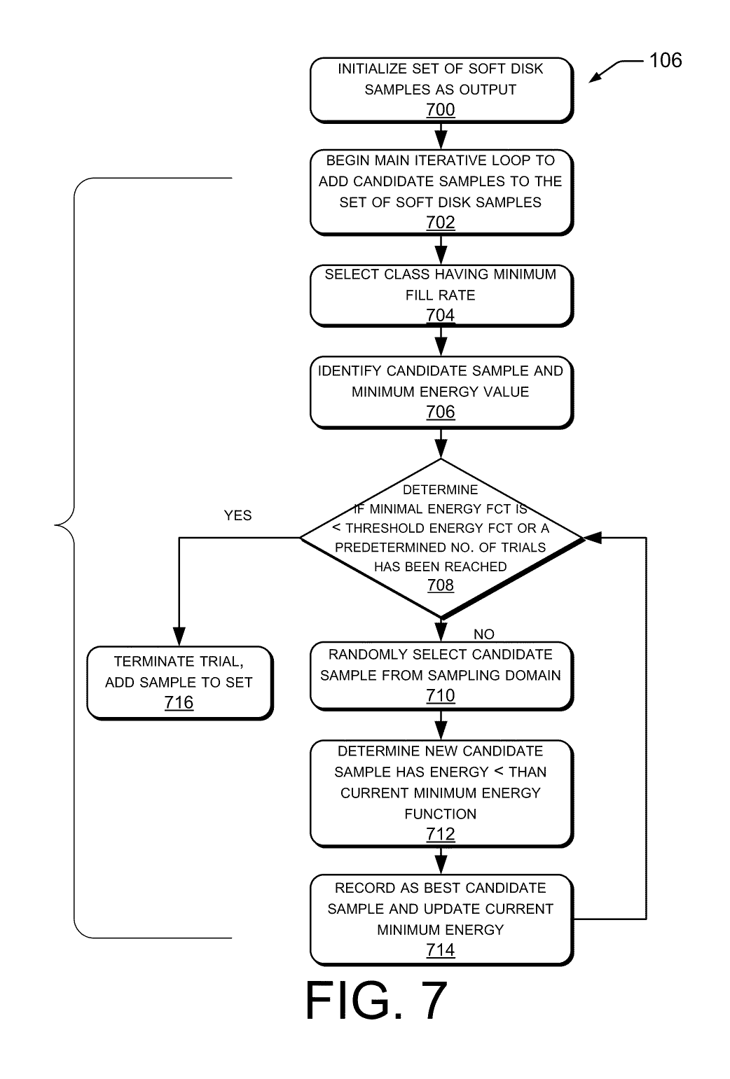

As discussed above, the soft disk sampling application component 208(a) interacts with the soft disk sampling component 206. The soft disk sampling application component 208(a) defines selection and arrangement of items in the context of any application, provides a display of the soft disk sampling process on a user interface, and interacts with information from the other components to provide the set of soft disk samples. Furthermore, the soft disk sampling application component 208(a) applies the generated set of soft disk samples to be used in a variety of graphic applications. The applications are discussed in FIG. 7.

The soft disk sampling process goes through trials. The fill rate component 308 determines the sample class that will be the recipient of a new sample at any given time during the sampling process. In an implementation, the fill rate component 308 identifies the sample class that is currently a most under-filled class among the possible classes. The fill rate component 308 operates by attempting to add a sample to the identified sample class.

The energy value calculator component 310 calculates the energy values or energy functions of the samples. The energy value calculator component 310 determines whether the samples are accepted or rejected to the sample set based on the calculated energy values or the calculated energy functions.

The soft disk generator component 312 generates the sample set of soft disk samples to be used in the graphics applications. The soft disk generator component 312 selects the samples from one or more sample classes determined at least in part on the calculated energy functions with a minimal value. In addition, the soft disk generator component 312 generates all of the sample classes together. For purposes of discussion, the term samples may be used interchangeably with the term, candidate samples.

The computing device 202 may include a soft disk sampling database 316 to store a collection of sampling domain, the samples in the sample classes, the set of samples generated, and the like.

The computing device 202 may also include additional removable storage 318 and/or non-removable storage 320. Any memory described herein may include volatile memory (such as RAM), nonvolatile memory, removable memory, and/or non-removable memory, implemented in any method or technology for storage of information, such as computer-readable storage media, computer-readable instructions, data structures, applications, program modules, emails, and/or other content. Also, the processor 300 described herein may include onboard memory in addition to or instead of the memory 302 shown in the figure. The memory may include storage media such as, but not limited to, random access memory (RAM), read only memory (ROM), flash memory, optical storage, magnetic disk storage or other magnetic storage devices, or any other medium which can be used to store the desired information and which can be accessed by the respective systems and devices.

The computing device 202 as described above may be implemented in various types of systems or networks. For example, the computing device 202 may be a part of, including but is not limited to, a client-server system, a peer-to-peer computer network, a distributed network, an enterprise architecture, a local area network, a wide area network, a virtual private network, a storage area network, and the like.

Various instructions, methods, techniques, applications, and modules described herein may be implemented as computer-executable instructions that are executable by one or more computers, servers, or telecommunication devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. The functionality of the program modules may be combined or distributed as desired in various implementations. An implementation of these modules and techniques may be stored on or transmitted across some form of computer-readable storage media.

### Exemplary Processes

FIGS. 4 and 6-8 are flowcharts showing illustrative processes for the phases mentioned above. The processes are illustrated as a collection of blocks in logical flowcharts, which represent a sequence of operations that can be implemented in hardware, software, or a combination. For discussion purposes, the processes are described with reference to the computing environment 200 shown in FIG. 2 and the computing device shown in FIG. 3. However, the processes may be performed using different environments and devices. Moreover, the environments and devices described herein may be used to perform different processes.

For ease of understanding, the methods are delineated as separate steps represented as independent blocks in the figures. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible for one or more of the provided steps to be omitted.

### Receive Sampling Domain

FIG. 4 illustrates an example process for performing the phase (discussed at a high level above) of receiving the sampling domain 210 for the soft disk sampling process 102. The sampling domain 210 may include a group of data items. The group of data items may correspond to an original digital image having data items associated with respective image elements.

The samples are data items selected from the sampling domain 210. The samples may convey various fields of information. For example, one part of the sample may identify a location of the sample within the sample domain. While another portion of the sample may convey at least one characteristic associated with the identified location. In another example, the sample received may describe at least a color value associated with a particular location. There is no limitation placed on the criterion or criteria in defining the information conveyed by the samples.

The samples may belong to the one or more sample classes 210(a), 210(b), . . . 210(n). The sample class refers to the collection of samples, where the collection may be defined based on at least one common characteristics of the samples or one common property that is shared. For example, a class of samples may pertain to image elements associated with a particular color (i.e., red, yellow, green, etc.). Another class of samples may pertain to a type of a physical object. While another class of samples may pertain to sensor elements. Yet, another class of samples may pertain to filter elements. There is no limitation placed on the criterion or criteria in defining the sample classes.

The number of sample classes may vary from one sample class to two or more sample classes. Having a multiple number of classes of soft disk samples is directly applicable to the variety of applications, such as distribution of cone and rod cells in human retinas, placement of multiple categories of objects, and the like.

At 400, the soft disk sampling component 206 may receive the number of samples for each sample class and the number of sample classes as specified by the user. From the sample numbers specification, the soft disk sampling component 206 may mathematically derive the effective radius values, defining the distance specified between any two samples in a particular class and another distance specified or calculated between the samples in a pair in different sample classes. The soft disk sampling component 206 uses a radius value r to measure a desired distance of each sample from another sample in a same class and in different classes. For example, the two types of radius values, intra-class radius values and inter-class radius values, govern the placement of samples. The intra-class radius value defines the desired distance between any two samples in a particular class of samples. For example, the distance may be specified between sample a in class I and sample b in class I. The inter-class radius value defines the desired distance specified or calculated between samples in a pair of different sample classes. For example, any sample in sample class A and any sample in sample class B.

The soft disk sampling component 206 may identify these parameters for the intra-class radius value where {rᵢ}_{i=0:c-1} is given for the desired amount of spacing for the individual classes. The soft disk sampling component 206 determines the inter-class radius value with the following equation:

$$\hat{r} ( s , {s}^{′} ) = \frac{r ( s , {c}_{s} , {c}_{{s}^{′}} ) + r ( {s}^{′} , {c}_{{s}^{′}} , {c}_{s} )}{2} \qquad ( 1 )$$

where s refers to a candidate sample from the sampling domain, s′ refers to any neighboring sample, cₛ is a class that s is associated with, and cₛ, is the class where s′ is associated with, as shown above. By receiving specifications or calculating the radius values, the soft disk sampling component 206 produces c classes of samples, so each class has a similar statistical distribution to a single class with parameter rᵢ, while a total sample set that includes the multiple classes of samples exhibits the blue noise distribution as well.

At 402, the fill rate component 308 determines which sample class to evaluate from for a next trial. To ensure that each class is well sampled throughout the entire process, the fill rate component 308 picks the next trial sample from the class that is currently most under-filled. The under-filled-ness is measured via FillRate, which is defined as a number of existing samples for a particular class over a target number of samples for that class.

At 404, the fill rate component 308 maintains an equal fill rate across the different classes throughout the sampling process. The fill rate component 308 uses the following equation to maintain equal fill rates, for a target number of samples of class i:

$${N}_{i} = N \frac{\frac{1}{{r}_{i}^{n}}}{{\sum }_{j = 0}^{c - 1} \frac{1}{{r}_{j}^{n}}} . \qquad ( 2 )$$

Here, Ni is the total number of target samples, n refers to the sample space dimension of the output, and {rᵢ} refers to the specified intra-class desired distance for class i. By maintaining equal fill rates among all of the classes by the fill rate component 308, leads to uniform sample distribution. The denominator of the above equation (2) operates by summing

$$\frac{1}{{r}_{j}^{n}}$$

over the possible classes. Based on this equation, the fill rate component 308 helps add samples to the different classes in a balanced manner.

At 406, the soft disk generator component 312 generates all of the sample classes together. The generation of the sample classes at the same time will ensure easy usage and uniform sample distribution. In another implementation, the soft disk generator component 312 may generate the classes sequentially, if the user desires so. Generating the classes sequentially may produce sample classes that take up a majority of the space. As a result, there may be little space available for future classes to be produced. Thus, the distribution of the samples may not necessarily be uniform.

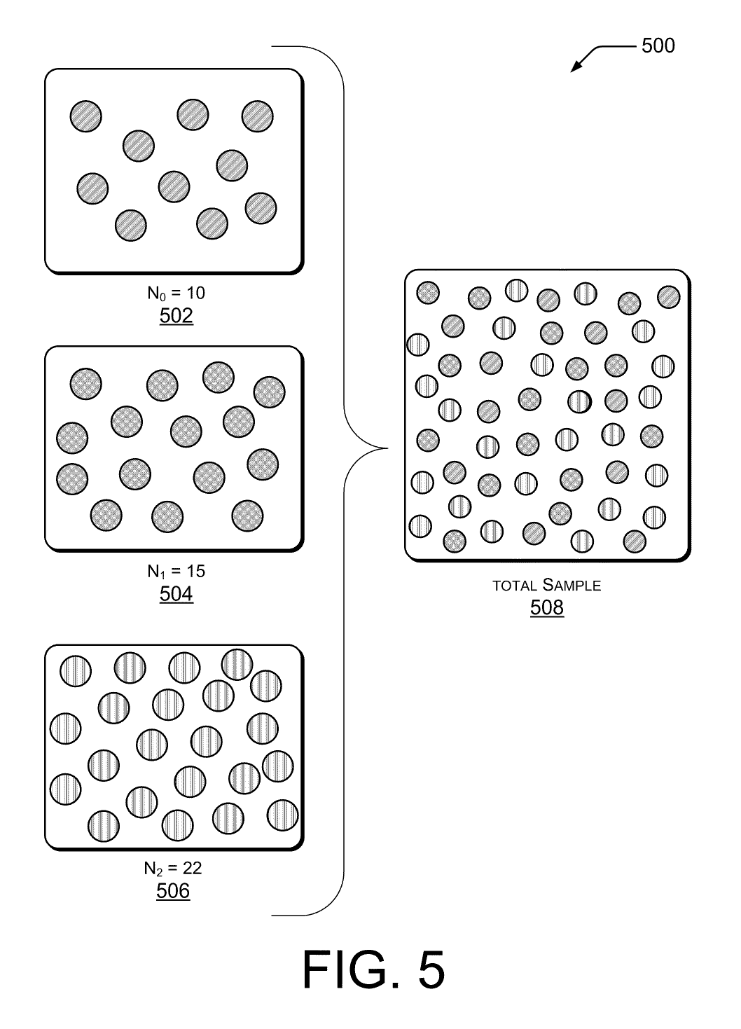

FIG. 5 illustrates an example process 500 of generating the sample classes. The soft disk sampling process offers control of sample count per class. The number of sample classes and the number of sample count per class may be specified by the user while the number of samples across the different classes is calculated using equation (2). As discussed above, the soft disk sampling component 206 selects candidate samples from three different classes of samples. The soft disk generator component 312 generates output information that may include three subsets of samples. For illustration purposes, a number of samples in sample classes shown are small but may range up to unlimited number of several thousand or more. At 502, is a first sample class generated with sample count of N₀=10. The samples in 502 are illustrated with slanted or angled lines in circular shapes. At 504, is a second sample class generated with sample count of N₁=16. The samples in 504 are shown with cross hatchet lines in circular shapes. At 506, is a third sample class generated with sample count of N₂=22. The samples in 506 are shown with vertical lines in circular shapes.

The sample set or a total sample 508 shows the samples that have been selected from the three different classes (also referred to as the subsets) based on the energy values. The sample set is an aggregate or sum of the number of samples from the each of the three subsets. Each sample class and the sample set exhibit blue noise distribution along with soft disk attributes, such as being deformable. The soft disk attribute includes being able to be transformed to another form or to alter a shape.

### Calculate Energy Function for Sample

FIG. 6 illustrates an example process of the phase (discussed at a high level above) of defining the energy function for the sample 104. The soft disk sampling component 206 receives the sampling domain as input, as described in FIG. 4.

The fill rate component 308 identifies the classes generated that are filled with soft disk samples 600. The soft disk generator component 312 selects the samples from the identified classes to be used in the soft disk sampling process, such as in the following two classes cₛ, c_{s′}.

The energy value calculator component 310 quantifies sample uniformity. It defines the energy function by using the following equation:

E(s)=Σ_{s′}, ω(cₛ, c_{s′})φ_{s′,σ}_{_{(s,s′)}}(s) (3)

where E is energy function or energy value, s refers to a candidate sample from the sampling domain, s′ refers to any neighboring sample, Cₛ is a class that s is associated with, and c_{s′} is the class where s′ is associated with, as shown above.

The energy value calculator component 310 specifies a scalar weight factor for a class combination 602. As shown above, w is a parameter where the user may specify different importance for the class combination (Cₛ, c_{s′}). In an implementation, the soft disk sampling component 206 may set ω=1, treating all of the classes equally.

The energy value calculator component 310 determines variance of a Gaussian blob, where the variance σ(s, s′) is a function of the sample pair (s, s′) 604. The variance a of the Gaussian blob φ_{s′,σ(s,s′)}(s) depends on its center s′ and on the candidate sample s. In an implementation, the Gaussian blobs that are beyond three standard deviations are cut off, in order to localize all energy updates and evaluations.

The desired spacing between the two samples, s′ and s, depends on their respective class identifications and their locations for adaptive sampling. In an implementation, σ(s,s′) may be linearly proportional to \hat{r}(s,s′) so the blob φ_{s′,σ(s,s′)}(s) may measure the energy according to the desired distance between s and s′. In another implementation, the setting σ(s, s′)=0.25×\hat{r}(s, s′) has been found to be satisfactory when used during the trials.

The equation to evaluate \hat{r} was shown previously as equation (1). The sample spacing parameters {rᵢ} may be estimated from the specified sample counts {Nᵢ} by setting rᵢ as r_{i,max}, the average inter-sample distance computed from the maximum packing of Nᵢ samples.

The soft disk sampling component 206 calculates the energy value of the sample s 606 by using equation (3) for E(s) shown above. The “calculation” of the energy function occurs in the iterative manner when the samples are generated or updated. The calculation of the energy function occurs throughout the entire sampling process.

### Generate Set of Soft Disk Samples

FIG. 7 illustrates an example process of the phase (discussed at a high level above) of generating the set of soft disk samples based on the energy function 106. The soft disk sampling component 206 receives the sampling domain, as described in FIG. 4 and receives the energy function E(s), as described in FIG. 6.

In an implementation, the soft disk sampling component 206 may further receive as input, information of user specified sample count per class or a number of sample classes.

FIG. 7 shows the soft disk sampling component 206 initializes a set of soft disk samples S as output 700.

The soft disk sampling component 206 begins a main iterative loop to add candidate samples to the set of soft disk samples 702. The sample s′ refers to the candidate sample that has been accepted and added to the set of soft disk samples S for output. For discussion purposes, “candidate samples” may be referred to as the samples from the sampling domain, which may be accepted or rejected for the set of soft disk samples.

The fill rate component 308 selects the sample class having the minimum fill rate 704. This sample class is currently the most under-filled class cₛ, and needs samples at this time. The fill rate component 308 may attempt to add randomly generated candidate sample s to the class cₛ. As mentioned, this may be performed by the fill rate component 308 when using the equal fill rate across different classes, where the target numbers of samples of class i, Ni may be computed using equation (2) as shown previously.

The soft disk sampling component 206 identifies the candidate sample and the minimum energy value for the candidate sample 706. When the candidate sample s is identified as null, the soft disk sampling component 206 selects the next candidate sample from the sampling domain. Furthermore, the soft disk sampling component 206 identifies the minimal energy function (initialized as infinite value before testing any samples) that is generating the next sample when the energy function is at a minimal value.

In an implementation, the soft disk sampling process may attempt to speed up the trial process by specifying the threshold energy function. The threshold energy function Eₜ may be specified by the user to allow for early termination of the trials. A second iterative loop begins at 708. The soft disk sampling component 206 determines if the minimal energy function of the candidate sample is less than the threshold energy function or a predetermined number of trials has been reached 708.

If the minimal energy function of the candidate sample is less than the threshold energy function, the process proceeds along the no to block 710. The soft disk sampling component 206 randomly selects another candidate sample from the sampling domain 710. As a result, the soft disk sampling component 206 may attempt more trials to identify the new sample with minimally possible energy and add the sample to the set of soft disk samples.

The soft disk sampling component 206 further determines if the new candidate sample has energy that is less than the current minimum energy function 712.

If this occurs, the soft disk sampling component 206 records it as a best candidate sample and updates the current minimum energy with its value 714. The soft disk sampling component 206 selects the current minimum energy function as the value of the energy function of the new sample candidate. Next, the soft disk sampling component 206 then adds the new sample candidate to the set of sample. The soft disk sampling component 206 completes the second iterative loop as shown on the left side. The loop proceeds from block 714 back to block 708. This second iterative loop is to determine among several candidate samples, which candidate sample has the minimum energy function.

Returning to block 708, if the minimal energy function of the candidate sample is less than the threshold energy function or the predetermined number of trials has been reached, the soft disk sampling component 206 proceeds along the left side to yes. Here, the soft disk sampling component 206 terminates the trial and adds the sample to the set 716. In other words, if the energy function of the candidate sample is less than the threshold function, the process is speed up with fewer trials.

In an implementation, the soft disk sampling component 206 may determine if the energy function of the trial sample E(s′) is less than the threshold energy function Eₜ. If the energy function of the trial sample E(s′) is less than the threshold energy function, E(s′)<Eₜ, the trial may be terminated. In another implementation, the threshold energy function Eₜ may be set to 0.01 to assist in speeding up the soft disk sampling process. On the other hand, if the energy function of the trial sample E(s′) is not less than the threshold energy function, the trial continues. In other words, the energy function of the trial sample E(s′) is greater than or equal to the threshold energy function Eₜ, E(s′)≧Eₜ. A minimal energy function is desired, which helps produce the uniform distribution. Until the minimal energy function or a predetermined maximum number of trials is reached, the sampling process continues with trials.

In yet another implementation, the soft disk sampling component 206 may determine whether the minimal energy function or value of the candidate sample is greater than or less than a predetermined threshold energy function or value. In an event that the energy function or value of the candidate sample is greater than the predetermined threshold energy function or value, the soft disk sampling component 206 will refrain from including the candidate sample in a the set of soft disk samples. In an event that the energy function or value is less than the predetermined threshold energy function or value, the soft disk sampling component 206 may include the candidate sample in the set of soft disk samples.

In an implementation, the generating of the set of soft disk samples S may be performed by using an algorithm, referred to as a multi-class soft dart throwing algorithm. The multi-class soft dart throwing algorithm follows:

Function S ← MultiClassSoftDartThrowing(Ω, {Nᵢ}_{i=0:c-1}, E(.), Eₜ)

//Ω: sampling domain
//{Nᵢ}: user specified sample count per class
// c: number of classes
//E(.): energy function defined in equation (3)
//Eₜ: (optional) user-specified energy threshold for speedup
S ← Ø//final set of samples
while not enough samples in S

cₛ ← arg min_{c} FilRate(c) // choose the most under filled class

s ← null
Eₘᵢₙ ← ∞

while Eₘᵢₙ ≧ Eₜ and not enough trials attempted
s′ ← new sample uniform-random drawn from Ω

if E(s′) < Eₘᵢₙ

s ← s′
Eₘᵢₙ ← E(s′)

end

end
add s to S

end
return S

In another implementation, the soft disk sampling process may be further refined by iteratively improving on the sample set. The samples may be moved anywhere in the sampling domain as long as the movement improves the uniformity of distribution. In order to shuffle a sample, several candidate locations are randomly drawn from the sampling domain. The soft disk sampling process selects a sample candidate location that most minimizes a maximum energy value. In particular, the sample candidate location selected is among the sample and the sample candidates of the candidate location. The sample and the sample candidate may swap locations. If the sampling domain is continuous, the sample candidate locations may almost be empty. This reduces the swapping to move the sample to the sample candidate location. If the sample domain is discrete, the sample candidate location may be a real sample. This may cause swapping the locations of the sample with the sample candidate of the sample candidate location to preserve sample counts.

### Sample Set Applied in Graphics Applications

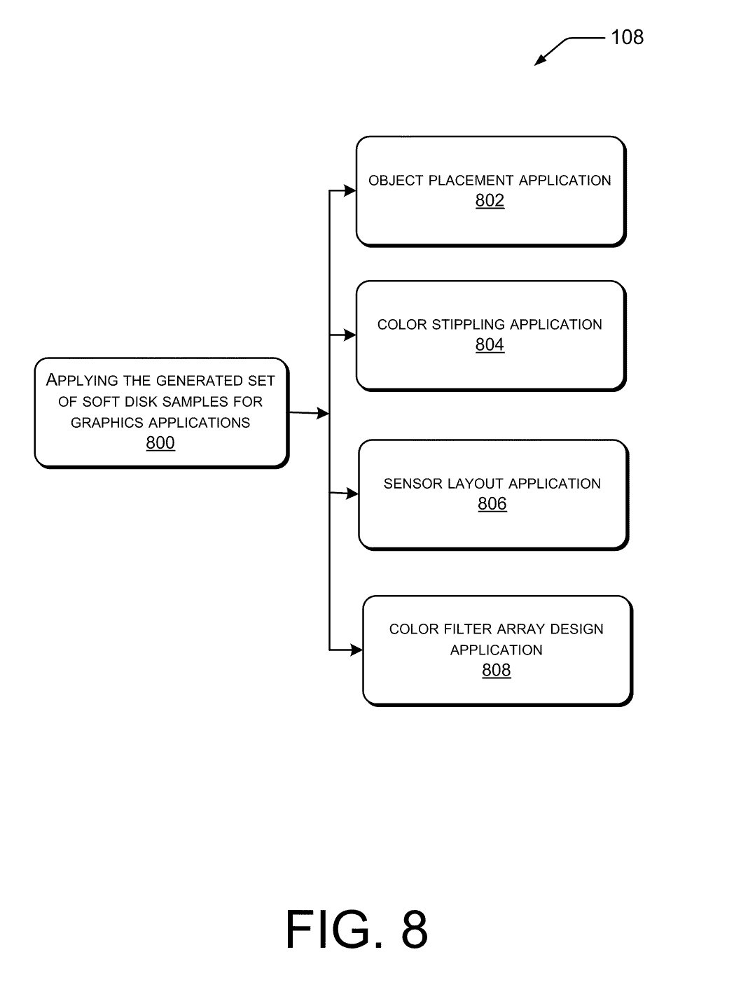

FIG. 8 illustrates an example process of the phase 108 (discussed at a high level above) of applying the generated set of soft disk samples for graphics applications 800. The soft disk sampling process receives the sampling domain, as described in FIG. 4, determines the calculated energy function E(s), as described in FIG. 6, and receives the generated set of soft disk samples, as described in FIG. 7.

Several graphics applications for soft disk sampling prefer the more uniform spatial distribution and exact specification of the number of samples per class. The soft disk sampling is suitable for both continuous and discrete settings.

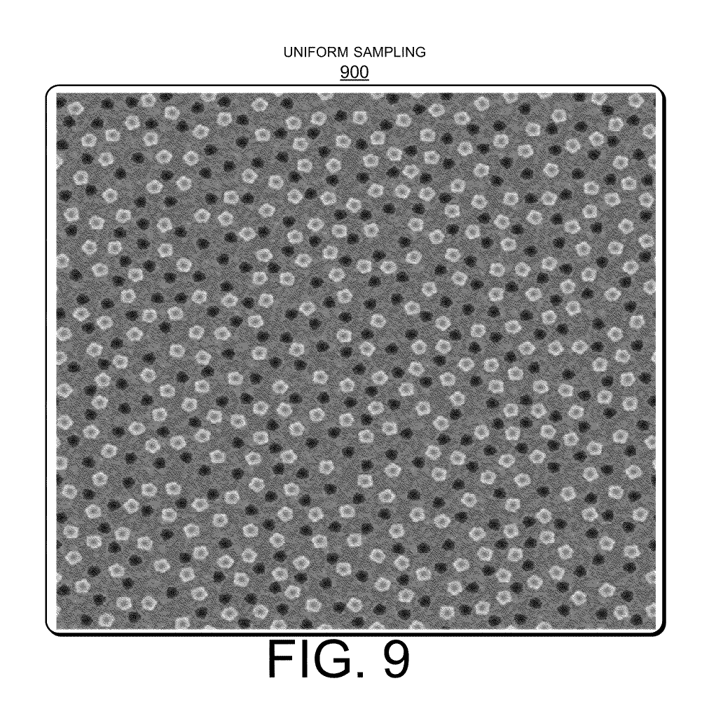

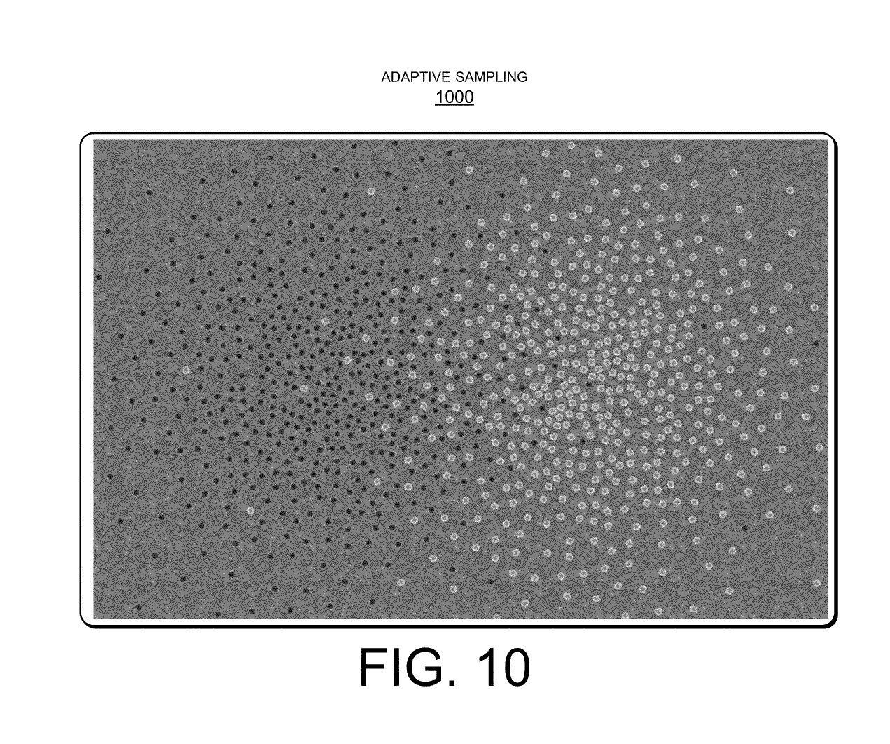

The soft disk generator component 312 applies the sample set for an object placement application 802. The sample set includes at least two or more sample classes of physical objects that are distributed uniformly. Uniform object placement is often desirable for both scientific (e.g., biological distribution) and artistic (e.g., procedural texture) applications. Examples of object placements are shown in FIGS. 9 and 10.

The soft disk generator component 312 applies the sample set for a color stippling application 804. The sample set includes at least two or more sample classes of color elements to maintain the blue noise distribution. The soft disk generator component 312 uses a color image as the input importance field, and treats each color channel as a separate class and produces a multi-class output sample set. This technique allows samples to be placed anywhere and thus provide more of a free-style pointillism effect. The colored dots follow the input importance and maintain a blue noise distribution.

The soft disk generator component 312 applies the sample set for a sensor layout application 806. The sample set includes at least two or more sample classes of sensor elements for a layout. The layout of the color sensor arrays determines the quality of the sampling results as well as subsequent reconstruction algorithms. In this approach, the soft disk sampling specifies the exact number of samples.

The soft disk generator component 312 applies the sample set for a color filter array design application 808. The sample set includes at least two or more sample classes of filter elements that are placed uniformly. This technique applies the multi-class soft disk sampling algorithm to a pre-determined regular set of samples. Furthermore, this technique reduces bias when compared to a regular layout while introducing less noise than a random layout.

The applications mentioned are in 2D but the techniques are directly applicable to higher dimensional spaces for scenarios like 3D object distribution.

FIG. 9 illustrates an example of classes of objects for object placement. The two classes of objects are: a first sample class is illustrated with a sample object of light colored flowers while a second sample class is illustrated with the sample object of dark colored flowers. Shown at 900, the placement of the two classes of sample objects may produce the uniform sampling 900 result. The uniform sampling 900 illustrates the two classes of samples are uniformly distributed.

FIG. 10 illustrates an example of classes of objects for object placement. The two classes of objects are: the first sample class is illustrated with a sample object of light colored flowers while the second sample class is illustrated with the sample object of dark colored flowers. In addition, the soft disk generator component 312 may place the two classes of objects from the set of samples to produce an adaptive sampling 1000. This is based on particular application needs.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method implemented at least partially by a processor, the method comprising:
receiving input of a sampling domain for graphics applications, the sampling domain including samples associated with one or more sample classes;
calculating energy functions for the samples from the one or more sample classes; and
generating output of a sample set by selecting the samples from one or more sample classes, the selecting of the samples is determined at least in part on the calculated energy functions, wherein each sample class and the sample set exhibit blue noise distribution.

2. The method of claim 1, wherein the receiving input of the sampling domain further comprises specifying a number of classes and specifying a number of samples from each sample class for the sample set.

3. The method of claim 1, wherein the receiving input of the sampling domain further comprises at least one of specifying or calculating a desired minimum distance between the samples in a same sample class.

4. The method of claim 1, wherein the receiving input of the sampling domain further comprises at least one of specifying or calculating a desired distance between a pair of samples belonging to different classes.

5. The method of claim 1, wherein the calculating the energy function further comprises:
centering a Gaussian blob around any sample in the sample set; and
determining a variance as a function of a sample pair, the sample pair includes the sample from the sampling domain and any sample in the sample set.

6. The method of claim 1, wherein the generating the output of the sample set that selects the samples from each of the sample classes is determined at least in part on having a lowest calculated energy function.

7. The method of claim 1, further comprising using the sample set for an object placement application, wherein the sample set includes one or more sample classes of physical objects that are distributed uniformly.

8. The method of claim 1, further comprising using the sample set for a color stippling application, wherein the sample set includes one or more sample classes of color elements to maintain the blue noise distribution.

9. The method of claim 1, further comprising using the sample set for a sensor layout application, wherein the sample set includes one or more sample classes of sensor elements for a layout.

10. The method of claim 1, further comprising using the sample set for a color filter array design application, wherein the sample set includes one or more sample classes of filter elements that are placed uniformly.

11. The method of claim 1, further comprising identifying a sample class that is currently a most under-filled class among at least two or more sample classes from the sampling domain, to provide an identified sample class.

12. The method of claim 1, further comprising determining whether the energy function for a sample from the sampling domain is greater than or less than a predetermined threshold energy function:
in an event that the energy function for a candidate sample from the sampling domain is greater than the predetermined threshold energy function, refraining from adding the candidate sample to the sample set; and
in an event that the energy function for the candidate sample from the sampling domain is less than the predetermined threshold energy function, adding the candidate sample to the sample set.

13. One or more computer-readable storage media encoded with instructions that, when executed by a processor, perform acts comprising:
selecting a sample class from a sampling domain, the sample class is currently a most under-filled class among at least two or more sample classes, to provide an identified sample class;
based on the identified sample class, generating a candidate sample associated with the identified sample class by using a random selection technique;
calculating an energy value of the candidate sample associated with the identified sample class; and
producing a sample set by selecting the candidate sample associated with the identified sample class to fill one or more sample classes based on whether the calculated energy value of the candidate sample is less than a minimum energy value.

14. The computer-readable storage media of claim 13, wherein the calculating the energy value of the candidate sample associated with the identified sample class further comprises:
centering a Gaussian blob around any candidate sample; and
determining a variance as a function of a pair of sample classes, the pair of sample classes includes the candidate sample associated with the identified sample class and any sample in the sample set.

15. The computer-readable storage media of claim 13, further comprising adding the candidate sample to the sample set based on the calculated energy value of the candidate sample is less than a predetermined threshold energy value.

16. The computer-readable storage media of claim 13, further comprising receiving input by specifying a number of samples for each sample class and specifying the number of samples from each sample class for the sample set.

17. The computer-readable storage media of claim 13, further comprising producing the output of the sample set where each sample class and the sample set exhibit a blue noise distribution with soft disk attributes.

18. A system comprising:
a processor;
a soft disk sampling component executed by the processor to receive input specifying a sampling domain including samples from one or more sample classes;
an energy function calculator component executed by the processor to calculate energy values of the samples from the one or more sample classes in the sampling domain; and
the soft disk generator component to produce a sample set selecting the samples based on the calculated energy values to fill the one or more sample classes.

19. The system of claim 18, wherein the soft disk sampling component is further to receive input by specifying a number of sample classes and a number of samples for each sample class.

20. The system of claim 18, wherein the soft disk generator component is further to determine whether the energy function for a candidate sample selected from the sampling domain is greater than or less than a predetermined threshold energy function:
in an event that the energy function for the candidate sample from the sampling domain is greater than the predetermined threshold energy function, refraining from adding the candidate sample to the sample set; and
in an event that the energy function for the candidate sample from the sampling domain is less than the predetermined threshold energy function, adding the candidate sample to the sample set.
